(19) United States
(12) Patent Application Publication
(10) Pub. No.: US 2014/0221550 A1
(43) Pub. Date: Aug. 7, 2014

(54) Foam Reinforced Structural Member

(71) Applicants: James T. McEvoy, Howell, MI (US); Patricia J. McClarren, Ypsilanti, MI (US); Alexander I. Balin, Ann Arbor, MI (US); Michael J. Thomas, Ann Arbor, MI (US)

(72) Inventors: James T. McEvoy, Howell, MI (US); Patricia J. McClarren, Ypsilanti, MI (US); Alexander I. Balin, Ann Arbor, MI (US); Michael J. Thomas, Ann Arbor, MI (US)

(21) Appl. No.: 14/233,254

(22) PCT Filed: Jul. 19, 2012
(86) PCT No.: PCT/US12/47291

§ 371 Date: Mar. 26, 2014

Related U.S. Application Data
(60) Provisional application No. 61/509,239, filed on Jul. 19, 2011.

(51) Int. Cl. C08L 75/04

(52) U.S. Cl. CPC C08L 75/04
USPC 524/500

(57) ABSTRACT

A composite material for reinforcing closed structural members as a tube or any closed profile section. More specifically, a composite material for filling metal tubes or any closed profile section forming the frame of vehicle seats to increase or maintain the strength of the seat frame while reducing the mass of the seat tubes or sealed profile section.

### CROSS-REFERENCE TO PRIOR APPLICATIONS

This U.S. National Stage patent application claims priority to International Application Serial No. PCT/US2012/047291 filed Jul. 19, 2012 entitled “Foam Reinforced Structural Member,” which claims the benefit of U.S. Provisional Patent Application Ser. No. 61/509,239 filed Jul. 19, 2011, entitled “Foam Reinforced Structural Member,” the entire disclosures of the applications being considered part of the disclosure of this application and hereby incorporated by reference.

### BACKGROUND OF THE INVENTION

1. Field of the Invention

The invention is generally directed to a composite material and method for reinforcing closed structural members, such as tubes or any member having a substantially closed profile section. More specifically, the invention is directed to a composite material and method for filling metal tubes or any member with a closed profile section, such as the tubes that form the frame of vehicle seats, to increase or maintain the strength of the member while allowing a reduction in the mass of the metal used, as well as a reduction in the total weight.

2. Description of the Prior Art

Structural support members such as frame members generally need a certain wall thickness to maintain a desired strength level against various stresses and forces. An example of a frame member includes frames for vehicle seats. Vehicle seats generally include a lower seat portion and an upper seat portion. The upper and lower seat portions are typically pivotably coupled together and include a seat frame split between the upper and lower portions for providing support and shape to the seat. The seat frame typically includes an upper frame portion located within the upper seat portion and a lower frame portion located in the lower seat portion. The seat frame is typically surrounded by a seat cushion, which is in turn covered by a surface material that forms the visible seating surface. While seat frames may be formed from a variety of materials and structures, many seat frames are generally formed from a tubular metal material, such as steel or a steel alloy. The frame generally has a closed profile section such as cylindrical square, rectangular, hexagonal tubes and other profiles.

The configuration of the vehicle seat causes the tubular seat frame, to experience unequal forces across its entirety. These unequal forces are especially acute while an occupant is sitting in the seat, such as in a reclined position or during crash conditions. More specifically, certain areas of the frame experience higher loads and stresses than other areas. As such, the entire tubular seat frame currently is designed to have sufficient material or thickness across its entirety to support expected maximum loads that occur in only limited positions or conditions. As the expected level of stress a tubular frame must endure increases, the weight and amount of material in the frame generally increases to provide sufficient support. While some techniques, such as using special alloys or, to a limited extent, variable wall thickness have been used, these techniques are expensive. In addition, the areas of the seat frame, other than those experiencing the minimum stress or load, have not successfully been reduced in material and weight while maintaining desired performance characteristics and maintaining or reducing cost of the seat frame.

Some manufacturers have attempted to fill the structural members, such as seat frames, with polyurethane foams or other urethane based foams to increase strength. Given the density of the polyurethane foam, the limited additional strength added, additional weight in many instances, and increased cost, these polyurethane filled tubes have had only limited success.

### SUMMARY OF THE INVENTION

The present invention is directed to a foam or composite reinforced closed structural member, a composite material or foam used to fill the structural member, and the method of filling the structural member with a composite material or foam. More specifically, the present invention is directed to a seat frame tube for use in a vehicle seat which is selectively filled with the composite material. The composite material is configured to allow heating, bending, and welding of the tube to the final shape of the closed structural member before, after, or simultaneous to the insertion of the composite material into the structural member. If the structural member is to be used in an application where it will be subject to unequally distributed forces, e.g. in a frame of a vehicle seat, the composite material can be selectively positioned into only portions of the structural member or tube which need reinforcement. The type of composite material, and the density and composition of the composite material, may be varied in the different portions of the structural member, depending on the amount of reinforcement required in those portions of the structural member.

In order to optimize the strength and weight of the reinforced structural member, the forces that the reinforced seat frame will be subjected to should first be analyzed. The thickness of the structural member may then be configured to be strong enough to withstand the forces likely to occur only in portions of the structural member encountering the least amount forces. The composite material is used in other portions of the structural member to reinforce against greater forces and stresses that will be experienced by the structural member. For example, if the structural member will be subjected to a ten Newton force in one portion but only a five Newton force in the rest of the structural member, then the thickness of the structural member over its entirety may be selected to be resistant to at least five Newtons of force, and the composite material will be selectively positioned within the structural member at the ten Newton force portions. The type, density, and location of the composite material may be selected to prevent failure of the structural member at various locations, maximize weight savings, provide a reduction in overall cost, and in some instances configure the cure time to ensure all forming operations are completed before the composite material hardens to a compound with structural rigidity.

The composition material is generally directed to a lightweight structural material held together with a binder. A flow aid may be used during insertion of the structural material into the tube. The structural material may be formed from cenospheres, such as WL 300, WL 150, or Perlite. The structural material forms 40-95% of the composite material, typically 45-75%.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front view of an exemplary upper seat frame including shaded areas representing exemplary locations for foam reinforcement;

FIG. 2 is a front view of a second exemplary upper seat frame including shaded areas representing exemplary locations for foam reinforcement;

FIG. 3 is a graph of load versus deflection of an exemplary foam reinforced tube against the same tube without urethane composite reinforcement;

FIG. 4 is a bar graph showing the weight of tubes with similar performance characteristics compared to an exemplary tube with foam reinforcement;

FIG. 5 is a graph of load versus deflection of an exemplary foam reinforced tubes versus empty tubes;

FIG. 6 is a cross-section of an exemplary static mixer;

FIG. 7 is a cross-section of an exemplary mechanical mixer;

FIG. 8 is a cross-section of an exemplary filled frame member; and

FIG. 9 is an enlarged illustration of various sized cenospheres.

### DETAILED DESCRIPTION OF THE ENABLING EMBODIMENTS

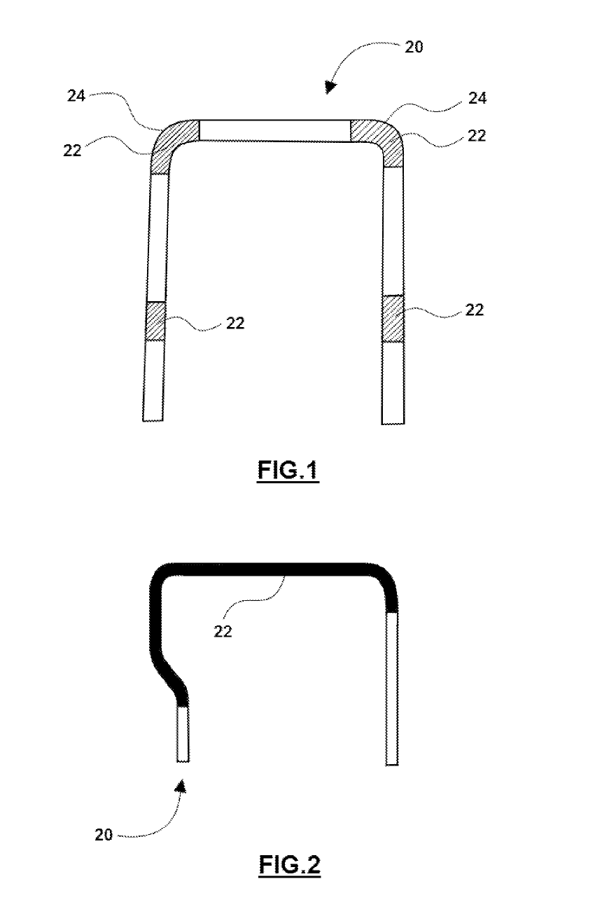

Referring to the Figures, wherein like numerals indicate corresponding parts throughout the several views, a structural member such as a tube 20 forming a seat frame is generally shown in FIGS. 1 and 2, as an upper seat frame reinforced with the composite material 22. The structural member or tube 20 of the exemplary embodiment is illustrated in the Figures as a back frame structure for a vehicle seat. However, it should be appreciated that the structural member 20 could be used in a wide range of other applications. For example, the structural member may be used for vehicle body stiffness and offset barrier performance for pillars and rails, as well as improved side impact performance in door bolsters. Additionally, the structural member 20 of the exemplary embodiment as illustrated in the Figures typically has a circular shape when viewed in cross-section; however, the structural member 20 could have any desirable cross-sectional shape, and the cross-section could vary along its length. The tube 20 is generally formed of a metallic material, but a non-metallic material could alternately be used. The size, shape, or configuration of the structural member may also vary as desired.

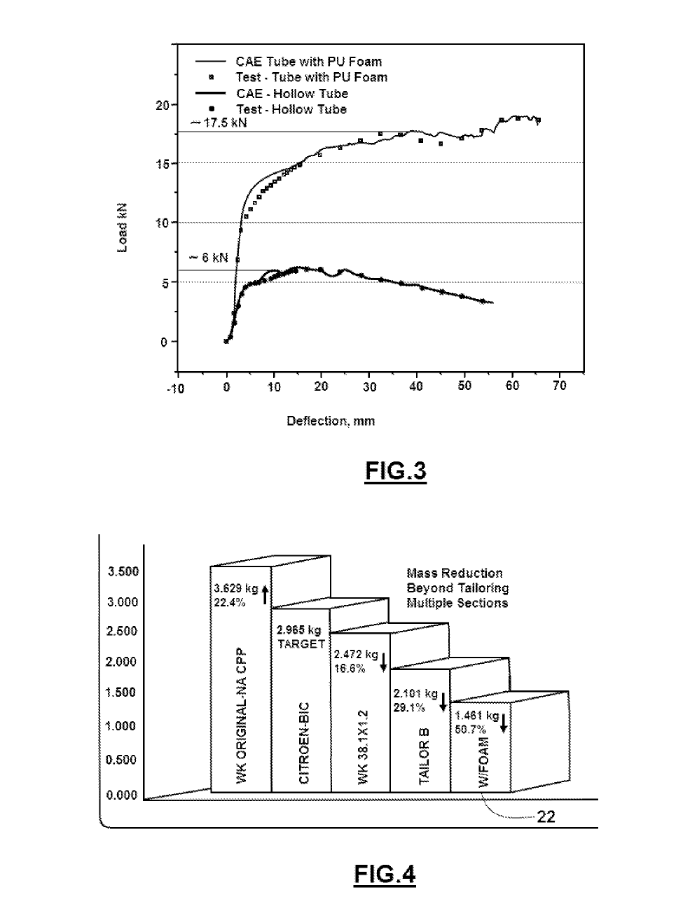

As shown in FIG. 3, the composite material 22 is selectively disposed in the interior of the tube 20 for reinforcing particular portions of the tube 20. In other words, the composite material 22 can be disposed in the portions of the tube 20 which require reinforcement, while other portions remain empty. The composite material 22 reinforcement lowers material costs by allowing for the tube 20 to be made of a thinner material, in turn minimizing the weight and costs of the reinforced tube 20. Localized application of the composite material 22 increases resistance to bending and stiffness of the structural member and enables wall thickness reduction for mass optimization. Additionally, the type of composite material 22 and the density of the composite material 22 may be varied in each of the different portions of the tube 20. Different densities of the composite material 22 may be used to further optimize structural geometry for mass reduction of the structural member 20. The density and composition of the composite material 22 are preferably selected based on the amount of reinforcement required for each of the portions of the tube 20 as well as weight considerations. For example, a dense composite material 22 capable of a high level of reinforcement could be positioned in a portion of the tube 20 subjected to heavy loads, whereas a less dense composite material 22 having less reinforcement capabilities but being lighter could be positioned in a portion of the tube 20 which needs less reinforcement. The dense composite material 22 is represented in the exemplary embodiment of FIG. 3 with darker shading as compared to the less dense composite material 22, which is represented with the lighter shading. However, it should be appreciated that increasing the density of the composite material 22 does not always increase the reinforcement of the tube 20, and therefore, the type and density of the composite material 22 should be carefully chosen. In addition, for certain materials, the structural material may have less density than the binder and other materials forming the composite material, and therefore, opposite the example above, the less dense composite material 22 provides greater reinforcement.

As shown in FIGS. 1 and 2, the reinforced tube 20 of the exemplary embodiment includes curved portions 24. As will be discussed in further detail below, these curved portions 24 can be formed in the tube 20 either before, during, or after the composite material 22 is inserted into the tube 20.

The structural members 20 may be strengthened with a variety of composite materials, including foam-like ceramic materials such as ceramic microspheres or cenospheres or foam-like composite materials including Perlite. For an average structural member used in seats, the system of the present invention allows for an average steel tube for a seat frame to be reduced in mass on average by about 0.8-2.0 kilograms, including the composite material. While this reduction in weight may vary depending on the size, shape, and configuration of the structural member 20, the weight reduction may be configured such that it does not cause a reduction in strength of the structural member. More specifically, the present invention uses a unique composite material construction that includes the addition of microspheres to allow for greater or equal performance requirements as current materials at a significant cost and mass reduction.

One problem with using standard polyurethane foams is that the polyurethane foam filled tube typically allows for a reduction in weight, but the overall filled tube product is more costly than a hollow steel tube. Therefore, the application of these polyurethane foam filled tubes has been very limited. In addition, the price of oil has a substantial correlation to the cost of the polyurethane component of these foam filled tubes, which causes variations in the overall cost of the reinforced structural members.

The present invention uses a unique composite material that in certain applications is a foam or foam-like composition and in other applications is not foam or foam-like, while improving the performance characteristics of the tube. The first composite material is a Perlite material. Perlite is very cost effective and the composite material may be formed from 30-95% by weight Perlite. The second material is microspheres or more specifically, a ceramic microspheres, also known as cenospheres, of various sizes that is almost as cost effective. The composite material may also be formed from 30-95% by weight of these ceramic microspheres. The third material may be a combination of ceramic microspheres, and/or Perlite, in total forming 30-95% by weight of the composite material. It should be recognized that the density of the structural material, specifically the Perlite or the microspheres, may vary, which also may vary the weight percent of the composite material that these form. For example, ceramic microspheres or cenospheres of differing sizes may also vary in density, and a less dense structural material will typically form a smaller percentage of the composite material by weight, as compared to a denser structural material. The above three types of materials, individually or in combination, may be used with a binder or a flow aid.

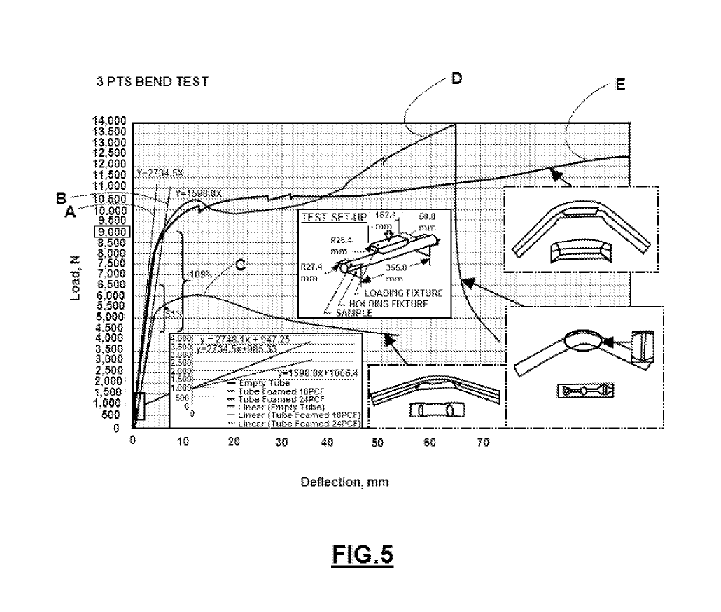

As illustrated in FIG. 3, using a tube filled with a reinforcing material provides greater load before deflection than a hollow tube, as well as no further increase in deflection at less load. As further illustrated in FIG. 4, the composite material of the present invention has almost half the weight of the other filler materials commonly used in tubes, including polyurethane foams. As further illustrated in FIG. 5, lines A and B illustrate a structural member filled with the composite material of the present invention and how the reinforced structural members had very little deflection for the applied load. In comparison, the empty tube, illustrated by line C, had the least amount of load before experience severe failure and high levels of deflection. In fact, the tube as the deflection increased required less force for additional deflection. Line D illustrates a tube filled with 24 PCF foam, which had more resistance to deflection than the hollow tube, but experienced a catastrophic failure at 14,000N load and a deflection of about 65 mm Line E illustrates a tube filled with 18 PCF foam, which also required less load before significant deflection of the structural member, as compared to the reinforced structural member with the composite material of the present invention. All of the tubes had an outside diameter of about 38 mm and a thickness of about 0.8 mm.

Perlite is an amorphous volcanic glass that includes a relatively high water content, typically formed by the hydration of obsidian. It occurs naturally and has the unusual property of greatly expanding when heated sufficiently and is commonly used in furnaces. It is an industrial mineral and a commercial product useful for its light-weight after processing. When dried, it is significantly reduced in weight and can be used as an expanding filler.

One advantage the inventors found with Perlite when used in structural members is that it is a glass and when it reaches temperatures of 850-900° C., it softens and water trapped in the structure of the material vaporizes, creating bubbles, and thereby expanding the material which in turn lowers the density. The vaporizing of the water causes an expansion of approximately 7-30 times its original volume. The expanded material is a brilliant white, due to the reflectivity of the trapped bubbles. Unexpanded (“raw”) Perlite has a bulk density around 1100 kg/m³ (1.1 g/cm³), while typical expanded Perlite has a bulk density of about 30-150 kg/m³. Therefore, Perlite has a significantly lower density than polyurethane foam formulations, which are typically 384 kg/m³. The enclosed structure of the tube can limit expansion, and the amount of Perlite inserted into the structural member 20 may need to be limited or the tube may be deformed by the expansion process. Therefore, the amount of Perlite added will also need to be controlled and will vary depending on the volume of the tube, the force to be exerted against the tube walls, and the desired density of the expanded Perlite.

The typical composition of Perlite is 70-75% silicon dioxide: SiO₂, 12-15% aluminum oxide: Al₂O₃, 3-4% sodium oxide: Na₂O, 3-5% potassium oxide: K₂O, 0.5-2% iron oxide: Fe₂O₃, 0.2-0.7% magnesium oxide: MgO, 0.5-1.5% calcium oxide: CaO, and 3-5% loss on ignition (chemical/combined water). Of course, as Perlite is a natural mineral, the amount of trapped water may vary, as well as the chemical composition. As such, the amount of Perlite used and its density after expansion may also vary, and will need to be addressed during manufacturing of the reinforced structural member. Perlite is a naturally occurring mineral and other impurities may exist and be included.

One formulation of a foam-like composite material 22 including Perlite generally includes: Polyol 15-65%, Water 0.1-0.5%, Perlite 10-60% and Methylene diphenyl diisocynate (“MDI”) 20-30%, preferably approximately 25% by weight. Another material found to be useful includes: Polyol 5-70%, Water 0.0-0.5%, Perlite 70-10% and MDI 20-30% by weight. These composite materials generally only cost 25% of the cost of typical polyurethane foam materials with similar performance characteristics.

The composite material 22 may use cenospheres or microspheres in place of or in addition to perlite as a structural material. Cenospheres are hollow ceramic microspheres that are typically a by-product of coal burning power plants. Cenospheres are produced at a high temperature of 1,500 to 1,750 degrees Celsius through complicated chemical and physical transformation. When pulverized coal is burned at power plants, fly ash is produced. The ceramic particles in fly ash have three types of structures. The first type of particles are solid and are called precipitators. The second type of particles are hollow and are called cenospheres. The third type of particles are called plerospheres, which are hollow particles of large diameter filled with smaller size precipitator and cenospheres. Due to the hollow structure, cenospheres have low density. The present invention uses the cenospheres as a structural material. Cenospheres are the lighter particles that are contained within the fly ash. Most cenospheres are “harvested” or scooped up from ash ponds. Ash ponds are the final resting place for fly ash when wet disposal is carried out. Some cenospheres are also collected at the power plants themselves. The wet microspheres are then dried, processed to specifications, and packaged to meet customer requirements. Their chemical composition and structure varies considerably depending on the composition of coal that generated them. More specifically, the properties of cenospheres depend on the consistency of the coal used and the operating parameters of the power plant. As long as the consistency and operating parameters remain constant, the cenospheres will be quite consistent. Cenospheres have a particle size range of 10-600 microns.

The inventors have found that cenospheres that are a tiny spheres with high ball-type rate or being more spherical in shape, and more specifically, with a substantially uniform spherical shape improve the flow rate, reduce the viscosity, and reduce the internal stress of resin pre-mixture. Therefore, during processing, less heat is produced in making the composite materials so as to prevent partial thermal decomposition. The cenospheres, as described above, also more evenly disperse in the mixture and reduce the amount of other chemicals typically needed, such as binders and flow aids, which also reduce VOC indicators and costs. The dimensional stability of the cenospheres when placed in tubes or other structural members has to be very high, and surprisingly, the cenospheres even allow subsequent shaping, bending, and welding of the structural member, with little to no detrimental effects. With an appropriate cenosphere/binder ratio, the impact resistance, surface hardness, and overall strength of the structural member may be significantly improved.

The density of high-performance hollow ceramic microspheres is only a fraction of that of polyurethane foams, as discussed above. Traditionally, only small amounts of hollow glass microspheres or cenospheres were used to replace heavier materials, such as being added in small quantities, no more than 10% by volume, to concrete. However, the inventors have surprisingly discovered that, when placed in structural members, high amounts of cenospheres such as 45-90% may be used. When considering the cost per unit volume, rather than cost per unit weight, high-performance hollow glass microspheres can significantly reduce costs.

The density of hollow glass microspheres is usually 0.20-0.60 g/cm³, the density of mineral filler is generally around 2.7-4.4 g/cm³ and the density of polyurethane is typically 0.384 g/cm³. The present invention uses cenospheres, which are low specific-gravity hollow ceramic beads which can range in diameter from approximately 25 to 300+ microns to reinforce the structural member. The method can be configured to yield a homogeneous mix or a non-homogeneous mix.

Cenospheres are relatively inexpensive, but quality can vary from batch-to-batch. Cenospheres have several limitations, including the variability and unpredictability of cenosphere physical properties, and the inability of the cenospheres to tolerate high-pressure levels, such as can be encountered in wellbore cementing when used in cement. As a commodity rather than an engineered product, cenospheres do not have well-defined values or quality parameters. Cenospheres are commonly segregated by flotation rather than graded by size or other parameters, and those cenospheres that float are shipped for use in the field. Nominal cenosphere density is 0.7 g/cc, but under minimal pressure of 500 psi or more, this value can increase to 0.85 g/cc. Cenospheres may also segregate partially by size during transport and handling, resulting in density variations in a slurry or premix.

The present invention specifically uses high-performance hollow glass microspheres as cenospheres as a kind of ultra-lightweight low cost inorganic filler in the composite material. Most cenospheres have a true density of 0.15-0.60 g/cm³ with 2-130 μm in diameter. In particular, the WL300 cenospheres have a bulk density of about 0.4 g/cm³ and an average compression strength of 6500 p.s.i., with a melting point of 1700-1900 degrees C., and 0.6-0.8 specific gravity. The average particle size for WL300 range from 10-350 microns, preferable 20-300 microns. Similar cenospheres are also available from Sphere Services under the trade name Bionic Bubble W-300.

Exemplary cenospheres may be found in Table 1.

TABLE 1

| Model density | Color | Diameter (μm) | | | Equivalent |
|---|---|---|---|---|---|
| (g/cm³) | (MPa) | 3M Product | True | Pressure | To |
| HS20 | White | 2-120 | 0.20 | 3-4 | K20 |
| HS25 | White | 2-110 | 0.25 | 5-7 | K25 |
| HS32 | White | 2-90 | 0.32 | 12-15 | S32 |
| HS40 | White | 2-85 | 0.40 | 28-33 | S38 |
| HS46 | White | 2-80 | 0.46 | 38-42 | K46 |
| HS60 | White | 8-65 | 0.60 | >60 | S60 |

The present invention may use a foam-like composite material with the following components: polyol 15-65%, water 0.1-0.5%, cenospheres 10-90%, preferably 25-75% and MDI 20-30%, preferably approximately 25% by weight. An alternative material found to be acceptable also includes: polyol 5-70%, water 0.0-0.5%, cenospheres 70-100%, and MDI 20-30%. The above formulations allow for a material cost of about only 15.5% the cost of the original polyurethane foam materials. Of course, a combination of Perlite and microspheres may be used.

The MDI may also be a high functionality polymeric diphenylmethane-diisocyanate (also referred to as a PMDI, however for purposes of this application PMDI will be referred to solely as MDI), such as Mondur 489 or M489 by Bayer. The M489 has a typical viscosity of 610-790 mPas at 25° C., a maximum acidity of 0.05% by weight and an NCO of 30.0-31.4% by weight. M489 is considered an aromatic isocyanate, and typically contains 60-100% polymeric Diphenylmethane, 20-30% 4,4′-Diphenylmethane Diisocyanate and 1-5% 2,4′-Diphenylmethane Diisocyanate. Other acceptable MDI substitutes as the polyol in the present invention include Varanol RA800 by DOW with a viscosity of about 17,500, Quadrol by BASF with a viscosity of about 52,000, Multranol 4050 by Bayer with a viscosity of about 18,0000, Lupranate M-20S having an NCO of 31.4% by weight and a viscosity of 200 cps at 25 degrees Celsius, and PAPI 901 MDI by DOW having a viscosity of 55 cps. The MDI is generally used as a binder for the cenospheres.

The polyol is generally an alcohol containing multiple hydroxyl groups, such as Hyperlite E-850, E-824 and Multranol 4050 and Hyperlite E-855 by Bayer. Hyperlite E-850 is a polymer polyol that is slightly hygroscopic and can become quite viscous at low temperatures. Hyperlite E-850 generally has a hydroxyl number of 18.2-22.2 mg K OH/g and a bulk density of 1054.47 kg/m³. Hyperlite Polyol E-824 is also made by Bayer and is a polyether polyol, with 28-56 hydroxyl, specifically 35.7 mg KOH/g. Multranol 4050, also by Bayer, is a 360-molecular-weight amine-based tetrafunctional polyether polyol. Multranol 4050 has a hydroxyl number of 600-660 mg KOH/g and a viscosity at 25° C. of 16,000-20,000 mPas with a bulk density at 25° C. of 1019.72 kg/m³. The polyol is generally used to react with the MDI to bind the cenospheres in place. Hyperlite E-855 is similar to Hyperlite E-850, but supplies a higher firmness in the final composition than Hyperlite E-850.

The polyol has hydroxyl functional groups available for reaction. The polyol used in the present invention has 5-15%, preferably 6-12% and more specifically, almost 8% free nitrogen. For example, the Hyperlite polyols have four nitrogen groups with two amine groups at each end plus a hydroxyl group. Therefore, the polyol of the present invention is not just any polyol, but one that is configured to act as almost a pure catalyst with the hydroxyl group.

Because the polyol acts as a catalyst with the MDI, or more specifically M489, the present invention uses polymeric acid to slow down the reaction process and therefore increase the open time. The polymeric acid has been found to increase the open time before the composition cures, while water has been found to speed up the cure process.

One advantage is that the composition may be formed without adding additional catalysts. It has also been found that higher levels of water cause faster setup times, such as a formulation with five parts water almost sets up immediately. Therefore, using less water slows the cure period, with a ½ part water providing a sufficient cure period for performing various shaping operations to the structural member before the composition hardens.

To make the material less dense, more water and polymeric acid may be added. The acid may be used to increase the cure time. The polymeric acid acts as a wetting agent and may include a catalyst blocker, to increase cure time of the composition as more is added. Therefore, by adding various amounts of water and polymeric acid, both the density and the cure time may be controlled. An example of polymeric acid is DABCO BA100 by Air Products and Chemicals, Inc. DABCO BA100 is greater than 80% polymeric acid and less than 0.4% ethylene glycol, although the overall chemical makeup of DABCO BA100 is a trade secret.

A nonreactive wetting agent or surfactant may also be used, with the surfactant being isocyanate compatible, such as a silicone polyether copolymer. The surfactant should be soluble in isocyanate and polyol premixes, so it can be stored with either the polyol or isocyanate premix. An example of an acceptable surfactant is DABCO DC5098. In the present invention, the surfactant is added to the isocyanate premix containing the cenospheres.

In some instances, catalysts may also be used to modify the cure time of the composition. For example, a water soluble tertiary amine catalyst such as Niax catalyst A-400 may be used as well as Niax catalyst A-440 and A4E. Another acceptable catalyst is SPI-402 by Specialty Products International, which includes a Bis(2-dimethylaminoethyl)ether. The catalysts are useful as less 8162 and more Hyperlite 4050 is used and typically may be used up to about 5% by weight.

Another exemplary composite material may be formed with Water 0.1-0.5%, Perlite and/or cenospheres 84.5%, and MDI of approximately 15% or Water 0.1-0.5%, Microspheres 84.5% and MDI 15%, or Water 0.1-0.5%, Perlite 0.1-84.5%, and Microspheres 0.1-84.5% and MDI of approximately 15%.

The above compositions that include a binder and having 30-70% Perlite or cenospheres, microspheres, or ceramic spheres, may be modified to have upwards of 95% Perlite, cenospheres, microspheres, or ceramic spheres by reducing or eliminating the binder and only adding up to 5% isocyanate. To fill the tubes, steam may need to be used during the processing steps to help the Perlite, cenospheres, and the like flow easily into the structural member to the proper location. As such, the composition may completely eliminate urethane or the binder in some embodiments and be formed of 95% Perlite, cenospheres, microspheres, or ceramic spheres, and 5% isocyanate with a steam being used to help process the composite material. Cenospheres, since they are generally very inexpensive as they are commonly occurring in clean industrial waste, they provide an environmentally friendly filler that increases the recycled contents of a vehicle and eliminates the petro-chemical-based urethane. However, the present invention uses selected cenospheres of certain size.

The isocyanate generally has a 3-48% free NCOs.

The present invention may also be formed of a mixture of Perlite, cenospheres, and/or ceramic spheres forming a combined amount up to 95% of the composite and up to 5% isocyanate with free NCO of 3-48% and processed with steam. More specifically, these typically have a formulation of 0.1-95% Perlite, 0.1-95% cenospheres, 1-5% isocyanate and 0.1-0.5% water.

Another formulation of the composite material may include urethane forming 10-30% and either Perlite or cenospheres forming 70-90%. In addition, the composite material may be formed of 10-30% of urethane with 0-97% and 0-90% cenospheres wherein the combined Perlite and cenospheres have a minimum of 70% of the composite material.

As illustrated in the tables below, the polyol to isocyanate premix ration may have a ratio of as high as 1.233 and as low as 0.4314. All of the examples in the tables used approximately 50-90 parts by weight cenospheres. The total polyol used in the examples was 100 parts by weight and the rest is based on this 100 part polyol. As further shown in the tables, typically a mixture of different polyols was used in place of a single type of polyol. Variation in the amount of water, specifically 0.1 to 3 parts by weight, was used, which can change the setup time, and no catalysts were used in the examples; however, as stated above, some catalysts may enhance the process. Each of the examples used various amounts of non-emissive polymeric acid to delay the catalystic reaction and to improve flow while keeping the desired cure time. A blocking agent was used in the examples from about 1.6 to 11.2 parts by weight. The isocyanate premix used 50-90 parts by weight and about 25 to 177 parts by weight. All of the examples included about 5 parts by weight of surfactant or DC5098.

TABLE 2

| | | | | | | | | |
|---|---|---|---|---|---|---|---|---|
| E855 | 30 | 20 | 10 | 5 | | 25 | 15 | 18 |
| E824 | | | | | | | | |
| 4050 | 70 | 70 | 70 | 70 | 70 | 70 | 70 | 70 |
| 8162 | | 10 | 20 | 25 | 30 | 5 | 15 | 12 |
| Water | 0.1 | 0.1 | 0.1 | 0.1 | 0.1 | 0.1 | 0.1 | 0.1 |
| Catalyst | | | | | | | | |
| A-1 | | | | | | | | |
| A-4 | | | | | | | | |
| A-107 | | | | | | | | |
| Ba 100 | 5.6 | 5.6 | 5.6 | 5.6 | 5.6 | 5.6 | 5.6 | 5.6 |
| Total | 105.7 | 105.7 | 105.7 | 105.7 | 105.7 | 105.7 | 105.7 | 105.7 |
| Equivalent | 0.81 | 0.88 | 0.95 | 0.98 | 1.02 | 0.84 | 0.91 | 0.89 |
| weight | | | | | | | | |
| Iso | | | | | | | | |
| 489 | 106.59 | 115.78 | 124.96 | 129.56 | 134.15 | 111.18 | 120.37 | 117.62 |
| Beads | | | | | | | | |
| WL300 | 70 | 70 | 70 | 70 | 70 | 70 | 70 | 70 |
| DC5098 | 5 | 5 | 5 | 5 | 5 | 5 | 5 | 5 |
| Total | 181.59 | 190.78 | 199.96 | 204.56 | 209.15 | 186.18 | 195.37 | 192.62 |
| Index 100 | 0.58 | 0.55 | 0.53 | 0.52 | 0.51 | 0.57 | 0.54 | 0.55 |
| Index 95 | 0.61 | 0.58 | 0.56 | 0.54 | 0.53 | 0.60 | 0.57 | 0.58 |

TABLE 3

| | | | | | | | | | |
|---|---|---|---|---|---|---|---|---|---|
| E855 | 30 | 20 | 10 | 5 | | 25 | 15 | 18 | 15 |
| E824 | | | | | | | | | 5 |
| 4050 | 70 | 70 | 70 | 70 | 70 | 70 | 70 | 70 | 70 |
| 8162 | | 10 | 20 | 25 | 30 | 5 | 15 | 12 | 10 |
| Water | 0.1 | 0.1 | 0.1 | 0.1 | 0.1 | 0.1 | 0.1 | 0.1 | 0.5 |
| Catalyst | | | | | | | | | |
| A-1 | | | | | | | | | |
| A-4 | | | | | | | | | |
| A-107 | | | | | | | | | |
| Ba 100 | 5.6 | 5.6 | 5.6 | 5.6 | 5.6 | 5.6 | 5.6 | 5.6 | 5.6 |
| Total | 105.7 | 105.7 | 105.7 | 105.7 | 105.7 | 105.7 | 105.7 | 105.7 | 106.1 |
| Equivalent | 0.81 | 0.88 | 0.95 | 0.98 | 1.02 | 0.84 | 0.91 | 0.89 | 0.92 |
| weight | | | | | | | | | |
| Iso | | | | | | | | | |
| 489 | 106.59 | 115.78 | 124.97 | 129.56 | 134.15 | 111.18 | 120.37 | 117.62 | 121.84 |
| Beads | | | | | | | | | |
| WL300 | 70 | 70 | 70 | 70 | 70 | 70 | 70 | 70 | 70 |
| DC5098 | 5 | 5 | 5 | 5 | 5 | 5 | 5 | 5 | 5 |
| Total | 181.59 | 190.78 | 199.97 | 204.56 | 209.15 | 186.18 | 195.37 | 192.62 | 196.84 |
| Index 100 | 0.58 | 0.55 | 0.53 | 0.52 | 0.51 | 0.57 | 0.54 | 0.55 | 0.54 |
| Index 95 | 0.61 | 0.59 | 0.56 | 0.54 | 0.53 | 0.60 | 0.57 | 0.58 | 0.57 |

TABLE 4

| | | | | | | | | | |
|---|---|---|---|---|---|---|---|---|---|
| E855 | 30 | 20 | 10 | 5 | | 25 | 15 | 18 | 15 |
| E824 | | | | | | | | | 5 |
| 4050 | 70 | 70 | 70 | 70 | 70 | 70 | 70 | 70 | 70 |
| 8162 | | 10 | 20 | 25 | 30 | 5 | 15 | 12 | 10 |
| Water | 0.8 | 0.8 | 0.8 | 0.8 | 0.8 | 0.8 | 0.8 | 0.8 | 0.8 |
| Catalyst | | | | | | | | | |
| A-1 | | | | | | | | | |
| A-4 | | | | | | | | | |
| A-107 | | | | | | | | | |
| Ba 100 | 5.6 | 5.6 | 5.6 | 5.6 | 5.6 | 5.6 | 5.6 | 5.6 | 5.6 |
| Total | 106.4 | 106.4 | 106.4 | 106.4 | 106.4 | 106.4 | 106.4 | 106.4 | 106.4 |
| Equivalent | 0.89 | 0.95 | 1.02 | 1.06 | 1.09 | 0.92 | 0.99 | 0.97 | 0.96 |
| weight | | | | | | | | | |
| Iso | | | | | | | | | |
| 489 | 116.86 | 126.04 | 135.23 | 139.83 | 144.42 | 121.45 | 130.64 | 127.88 | 126.24 |
| Beads | | | | | | | | | |
| WL300 | 70 | 70 | 70 | 70 | 70 | 70 | 70 | 70 | 70 |
| DC5098 | 5 | 5 | 5 | 5 | 5 | 5 | 5 | 5 | 5 |
| Total | 191.86 | 201.04 | 210.23 | 214.83 | 219.42 | 196.45 | 205.64 | 202.88 | 201.24 |
| Index 100 | 0.55 | 0.53 | 0.51 | 0.50 | 0.48 | 0.54 | 0.52 | 0.52 | 0.53 |
| Index 95 | 0.58 | 0.56 | 0.53 | 0.52 | 0.51 | 0.57 | 0.54 | 0.55 | 0.56 |

TABLE 5

| | | | | | | | | | |
|---|---|---|---|---|---|---|---|---|---|
| E855 | 30 | 20 | 10 | 5 | | 25 | 15 | 18 | 15 |
| E824 | | | | | | | | | 5 |
| 4050 | 70 | 70 | 70 | 70 | 70 | 70 | 70 | 70 | 70 |
| 8162 | | 10 | 20 | 25 | 30 | 5 | 15 | 12 | 10 |
| Water | 1 | 1 | 1 | 1 | 1 | 1 | 1 | 1 | 1 |
| Catalyst | | | | | | | | | |
| A-1 | | | | | | | | | |
| A-4 | | | | | | | | | |
| A-107 | | | | | | | | | |
| Ba 100 | 5.6 | 5.6 | 5.6 | 5.6 | 5.6 | 5.6 | 5.6 | 5.6 | 5.6 |
| Total | 106.6 | 106.6 | 106.6 | 106.6 | 106.6 | 106.6 | 106.6 | 106.6 | 106.6 |
| Equivalent | 0.91 | 0.98 | 1.05 | 1.08 | 1.12 | 0.94 | 1.01 | 0.99 | 0.98 |
| weight | | | | | | | | | |
| Iso | | | | | | | | | |
| 489 | 119.79 | 128.98 | 138.16 | 142.76 | 147.35 | 124.38 | 133.57 | 130.82 | 129.17 |
| Beads | | | | | | | | | |
| WL300 | 70 | 70 | 70 | 70 | 70 | 70 | 70 | 70 | 70 |
| DC5098 | 5 | 5 | 5 | 5 | 5 | 5 | 5 | 5 | 5 |
| Total | 194.79 | 203.98 | 213.17 | 217.76 | 222.35 | 199.38 | 208.57 | 205.82 | 204.17 |
| Index 100 | 0.55 | 0.52 | 0.50 | 0.49 | 0.48 | 0.54 | 0.51 | 0.52 | 0.52 |
| Index 95 | 0.57 | 0.55 | 0.53 | 0.51 | 0.50 | 0.56 | 0.54 | 0.54 | 0.55 |

TABLE 6

| | | | | | | | | |
|---|---|---|---|---|---|---|---|---|
| E855 | 30 | 20 | 10 | 5 | | 25 | 15 | 18 |
| E824 | | | | | | | | |
| 4050 | 70 | 70 | 70 | 70 | 70 | 70 | 70 | 70 |
| 8162 | | 10 | 20 | 25 | 30 | 5 | 15 | 12 |
| Water | 3 | 3 | 3 | 3 | 3 | 3 | 3 | 3 |
| Catalyst | | | | | | | | |
| A-1 | | | | | | | | |
| A-4 | | | | | | | | |
| A-107 | | | | | | | | |
| Ba 100 | 5.6 | 5.6 | 5.6 | 5.6 | 5.6 | 5.6 | 5.6 | 5.6 |
| Total | 108.6 | 108.6 | 108.6 | 108.6 | 108.6 | 108.6 | 108.6 | 108.6 |
| Equivalent | 1.13 | 1.20 | 1.27 | 1.30 | 1.34 | 1.16 | 1.23 | 1.21 |
| weight | | | | | | | | |
| Iso | | | | | | | | |
| 489 | 149.12 | 158.31 | 167.50 | 172.09 | 176.68 | 153.72 | 162.90 | 160.15 |
| Beads | | | | | | | | |
| WL300 | 70 | 70 | 70 | 70 | 70 | 70 | 70 | 70 |
| DC5098 | 5 | 5 | 5 | 5 | 5 | 5 | 5 | 5 |
| Total | 224.12 | 233.31 | 242.50 | 247.09 | 251.68 | 228.72 | 237.90 | 235.15 |
| Index 100 | 0.48 | 0.47 | 0.45 | 0.44 | 0.43 | 0.47 | 0.46 | 0.46 |
| Index 95 | 0.51 | 0.49 | 0.47 | 0.46 | 0.45 | 0.50 | 0.48 | 0.48 |

TABLE 7

| | | | | | | | | |
|---|---|---|---|---|---|---|---|---|
| E855 | 30 | 20 | 10 | 5 | | 25 | 15 | 18 |
| E824 | | | | | | | | |
| 4050 | 70 | 70 | 70 | 70 | 70 | 70 | 70 | 70 |
| 8162 | | 10 | 20 | 25 | 30 | 5 | 15 | 12 |
| Water | 0.1 | 0.1 | 0.1 | 0.1 | 0.1 | 0.1 | 0.1 | 0.1 |
| Catalyst | | | | | | | | |
| A-1 | | | | | | | | |
| A-4 | | | | | | | | |
| A-107 | | | | | | | | |
| Ba 100 | 11.2 | 11.2 | 11.2 | 11.2 | 11.2 | 11.2 | 11.2 | 11.2 |
| Total | 111.3 | 111.3 | 111.3 | 111.3 | 111.3 | 111.3 | 111.3 | 111.3 |
| Equivalent | 0.81 | 0.88 | 0.95 | 0.98 | 1.02 | 0.84 | 0.91 | 0.89 |
| weight | | | | | | | | |
| Iso | | | | | | | | |
| 489 | 106.59 | 115.78 | 124.96 | 129.56 | 134.15 | 111.18 | 120.37 | 117.62 |
| Beads | | | | | | | | |
| WL300 | 50 | 50 | 50 | 50 | 50 | 50 | 50 | 50 |
| DC5098 | 5 | 5 | 5 | 5 | 5 | 5 | 5 | 5 |
| Total | 161.59 | 170.78 | 179.96 | 184.56 | 189.15 | 166.18 | 175.37 | 172.62 |
| Index 100 | 0.69 | 0.65 | 0.62 | 0.60 | 0.59 | 0.67 | 0.63 | 0.64 |
| Index 95 | 0.72 | 0.68 | 0.65 | 0.63 | 0.62 | 0.70 | 0.67 | 0.68 |

TABLE 8

| | | | | | | | | | |
|---|---|---|---|---|---|---|---|---|---|
| E855 | 30 | 50 | 50 | 50 | 40 | 50 | 40 | 30 | 20 |
| E824 | | 20 | 30 | 40 | 50 | | | 10 | 10 |
| 4050 | 70 | 10 | 10 | 10 | 10 | 10 | 10 | 10 | 20 |
| 8162 | | 20 | 10 | | | 40 | 50 | 50 | 50 |
| Water | 0.5 | 0.5 | 0.5 | 0.5 | 0.5 | 0.5 | 0.5 | 0.5 | 0.5 |
| Catalyst | | | | | | | | | |
| A-1 | | | | | | | | | |
| A-4 | | | | | | | | | |
| A-107 | | | | | | | | | |
| Ba 100 | 11.2 | 1.6 | 1.6 | 1.6 | 1.6 | 1.6 | 1.6 | 1.6 | 3.2 |
| Total | 111.7 | 102.1 | 102.1 | 102.1 | 102.1 | 102.1 | 102.1 | 102.1 | 103.7 |
| Equivalent | 0.85 | 0.34 | 0.28 | 0.21 | 0.21 | 0.48 | 0.55 | 0.55 | 0.66 |
| weight | | | | | | | | | |
| Iso | | | | | | | | | |
| 489 | 112.46 | 45.42 | 36.61 | 27.81 | 28.19 | 63.03 | 72.22 | 72.60 | 86.96 |
| Beads | | | | | | | | | |
| WL300 | 50 | 50 | 50 | 50 | 50 | 50 | 50 | 50 | 50 |
| DC5098 | 5 | 5 | 5 | 5 | 5 | 5 | 5 | 5 | 5 |
| Total | 167.46 | 100.42 | 91.61 | 82.81 | 83.19 | 118.03 | 127.22 | 127.60 | 141.96 |
| Index 100 | 0.67 | 1.02 | 1.11 | 1.23 | 1.23 | 0.87 | 0.80 | 0.80 | 0.73 |
| Index 95 | 0.70 | 1.07 | 1.17 | 1.29 | 1.29 | 0.91 | 0.84 | 0.84 | 0.77 |

TABLE 9

| | | | | | | | | | |
|---|---|---|---|---|---|---|---|---|---|
| E855 | 30 | 50 | 50 | 50 | 40 | 50 | 40 | 30 | 20 |
| E824 | | 20 | 30 | 40 | 50 | | | 10 | 10 |
| 405 | 70 | 10 | 10 | 10 | 10 | 10 | 10 | 10 | 20 |
| 8162 | | 20 | 10 | | | 40 | 50 | 50 | 50 |
| Water | 0.8 | 0.8 | 0.8 | 0.8 | 0.8 | 0.8 | 0.8 | 0.8 | 0.8 |
| Catalyst | | | | | | | | | |
| A-1 | | | | | | | | | |
| A-4 | | | | | | | | | |
| A-107 | | | | | | | | | |
| Ba 100 | 11.2 | 1.6 | 1.6 | 1.6 | 1.6 | 1.6 | 1.6 | 1.6 | 3.2 |
| Total | 112 | 102.4 | 102.4 | 102.4 | 102.4 | 102.4 | 102.4 | 102.4 | 104 |
| Equivalent | 0.89 | 0.38 | 0.31 | 0.24 | 0.25 | 0.51 | 0.58 | 0.58 | 0.69 |
| weight | | | | | | | | | |
| Iso | | | | | | | | | |
| 489 | 116.86 | 49.82 | 41.01 | 32.21 | 32.59 | 67.43 | 76.62 | 77.00 | 91.36 |
| Beads | | | | | | | | | |
| WL300 | 50 | 50 | 50 | 50 | 50 | 50 | 50 | 50 | 50 |
| DC5098 | 5 | 5 | 5 | 5 | 5 | 5 | 5 | 5 | 5 |
| Total | 171.86 | 104.82 | 96.01 | 87.21 | 87.59 | 122.43 | 131.62 | 132.00 | 146.36 |
| Index 100 | 0.65 | 0.98 | 1.07 | 1.17 | 1.17 | 0.84 | 0.78 | 0.78 | 0.71 |
| Index 95 | 0.68 | 1.03 | 1.12 | 1.23 | 1.23 | 0.88 | 0.82 | 0.81 | 0.75 |

TABLE 10

| | | | | | | | | | |
|---|---|---|---|---|---|---|---|---|---|
| E855 | 30 | 50 | 50 | 50 | 40 | 50 | 40 | 30 | 20 |
| E824 | | 20 | 30 | 40 | 50 | | | 10 | 10 |
| 4050 | 70 | 10 | 10 | 10 | 10 | 10 | 10 | 10 | 20 |
| 8162 | | 20 | 10 | | | 40 | 50 | 50 | 50 |
| Water | 1 | 1 | 1 | 1 | 1 | 1 | 1 | 1 | 1 |
| Catalyst | | | | | | | | | |
| A-1 | | | | | | | | | |
| A-4 | | | | | | | | | |
| A-107 | | | | | | | | | |
| Ba 100 | 11.2 | 1.6 | 1.6 | 1.6 | 1.6 | 1.6 | 1.6 | 1.6 | 3.2 |
| Total | 112.2 | 102.6 | 102.6 | 102.6 | 102.6 | 102.6 | 102.6 | 102.6 | 104.2 |
| Equivalent | 0.91 | 0.40 | 0.33 | 0.27 | 0.27 | 0.53 | 0.60 | 0.61 | 0.71 |
| weight | | | | | | | | | |
| Iso | | | | | | | | | |
| 489 | 119.79 | 52.75 | 43.95 | 35.14 | 35.52 | 70.36 | 79.55 | 79.93 | 94.29 |
| Beads | | | | | | | | | |
| WL300 | 50 | 50 | 50 | 50 | 50 | 50 | 50 | 50 | 50 |
| DC5098 | 5 | 5 | 5 | 5 | 5 | 5 | 5 | 5 | 5 |
| Total | 174.79 | 107.75 | 98.95 | 90.14 | 90.52 | 125.36 | 134.55 | 134.93 | 149.29 |
| Index 100 | 0.64 | 0.95 | 1.04 | 1.14 | 1.13 | 0.82 | 0.76 | 0.76 | 0.70 |
| Index 95 | 0.67 | 1.00 | 1.09 | 1.20 | 1.19 | 0.86 | 0.80 | 0.80 | 0.73 |

TABLE 11

| | | | | | | | | | |
|---|---|---|---|---|---|---|---|---|---|
| E855 | 30 | 50 | 50 | 50 | 40 | 50 | 40 | 30 | 20 |
| E824 | | 20 | 30 | 40 | 50 | | | 10 | 10 |
| 4050 | 70 | 10 | 10 | 10 | 10 | 10 | 10 | 10 | 20 |
| 8162 | | 20 | 10 | | | 40 | 50 | 50 | 50 |
| Water | 3 | 3 | 3 | 3 | 3 | 3 | 3 | 3 | 3 |
| Catalyst | | | | | | | | | |
| A-1 | | | | | | | | | |
| A-4 | | | | | | | | | |
| A-107 | | | | | | | | | |
| Ba 100 | 11.2 | 1.6 | 1.6 | 1.6 | 1.6 | 1.6 | 1.6 | 1.6 | 3.2 |
| Total | 114.2 | 104.6 | 104.6 | 104.6 | 104.6 | 104.6 | 104.6 | 104.6 | 106.2 |
| Equivalent | 1.13 | 0.62 | 0.56 | 0.49 | 0.49 | 0.76 | 0.82 | 0.83 | 0.94 |
| weight | | | | | | | | | |
| Iso | | | | | | | | | |
| 489 | 149.12 | 82.09 | 73.28 | 64.47 | 64.86 | 99.70 | 108.88 | 109.27 | 123.63 |
| Beads | | | | | | | | | |
| WL300 | 50 | 50 | 50 | 50 | 50 | 50 | 50 | 50 | 50 |
| DC5098 | 5 | 5 | 5 | 5 | 5 | 5 | 5 | 5 | 5 |
| Total | 204.12 | 137.09 | 128.28 | 119.47 | 119.86 | 154.70 | 163.88 | 164.27 | 178.63 |
| Index 100 | 0.56 | 0.76 | 0.82 | 0.88 | 0.87 | 0.68 | 0.64 | 0.64 | 0.59 |
| Index 95 | 0.59 | 0.80 | 0.86 | 0.92 | 0.92 | 0.71 | 0.67 | 0.67 | 0.62 |

TABLE 12

| | | | | | | | | | |
|---|---|---|---|---|---|---|---|---|---|
| E855* | 30 | 50 | 50 | 50 | 40 | 50 | 40 | 30 | 20 |
| E824** | | 20 | 30 | 40 | 50 | | | 10 | 10 |
| 4050*** | 70 | 10 | 10 | 10 | 10 | 10 | 10 | 10 | 20 |
| 8162**** | | 20 | 10 | | | 40 | 50 | 50 | 50 |
| Water | 0.1 | 0.3 | 0.5 | 0.8 | 1 | 1.5 | 1.8 | 2 | 3 |
| Catalyst | | | | | | | | | |
| A-1 | | | | | | | | | |
| A-4***** | | | | | | | | | |
| A-107 | | | | | | | | | |
| Ba 100 | 11.2 | 1.6 | 1.6 | 1.6 | 1.6 | 1.6 | 1.6 | 1.6 | 3.2 |
| Total | 111.3 | 101.9 | 102.1 | 102.4 | 102.6 | 103.1 | 103.4 | 103.6 | 106.2 |
| Equivalent | 0.81 | 0.32 | 0.28 | 0.24 | 0.27 | 0.59 | 0.69 | 0.72 | 0.94 |
| weight | | | | | | | | | |
| Iso | | | | | | | | | |
| 489****** | 106.59 | 42.49 | 36.61 | 32.21 | 35.52 | 77.70 | 91.28 | 94.60 | 123.63 |
| Beads | | | | | | | | | |
| WL300 | 90 | 90 | 90 | 90 | 90 | 90 | 90 | 90 | 90 |
| DC5098 | 5 | 5 | 5 | 5 | 5 | 5 | 5 | 5 | 5 |
| Total | 201.59 | 137.49 | 131.61 | 127.21 | 130.52 | 172.70 | 186.28 | 189.60 | 218.63 |
| Index 100 | 0.55 | 0.74 | 0.78 | 0.81 | 0.79 | 0.60 | 0.56 | 0.55 | 0.49 |
| Index 95 | 0.58 | 0.78 | 0.81 | 0.85 | 0.83 | 0.63 | 0.59 | 0.57 | 0.51 |

In forming the seat tube, one method is to cut the tube 20 to a predetermined length. At least one portion of the tube 20 is then filled with the composite material 22 to reinforce that portion of the tube 20. As is described in further detail below, the composite material 22 is preferably inserted into the tube 20 by injecting a base material into the tube 20, using a mix head that combines the isocyanate premix with the polyol premix. In some formulations the composite material may need to be further processed through heat allowing the base material to expand to become the desired structural reinforcing composite material 22. However, it should be appreciated that other processes could be used to insert the composite material 22 into the structural member 20. As explained above, the entire length of the structural member 20 does not have to be filled with composite material 22, and the type and density of the composite material 22 can be varied in different portions of the tube 20. Next, the structural member 20, if required, is bent into a final shape, e.g. the shape shown in FIGS. 1 and 2. To assist with bending of the structural member 20, the structural member 20 may be heated before bending in order to allow the structural member 20 to have smaller bend radiuses. If the structural member 20 is not heated before bending, then the structural member 20 may crimp or deform if bent too sharply. If the composite material 22 is positioned in the portions of the structural member 20 to be bent, then the structural member 20 is heated to a temperature which will not degrade the composite material 22 disposed therein. Once the structural member has been bent and then cooled, the structural member 20 can be utilized as the seat frame for a vehicle seat. The above exemplary method is advantageous because it is simple to inject the resin into the tube 20 before the tube 20 is bent. Additional forming operations, such as shaping or welding the structural member may also occur while the composite material is within the structural member.

An exemplary method of preparing the composite material is to prepare an isocyanate premix and a polyol premix. The isocyanate premix is prepared by mixing the wetting agent, such as DC5098 with the M489 and the cenospheres in a static mixer at 150 degrees F. The polyol premix is prepared by mixing the polyols with water and BA100 in a static mixer at room temperature conditions. The two premixes are added to a lance cylinder machine to make the correct volumetric ratio of the polyol/isocyanate mixtures and is injected into the structural member. The mix time may vary depending on the required open time of premixes and the composite material.

Of course, the structural member 20 may be cut to a predetermined length, bent, and then filled with composite material 22, and the type and density of the composite material 22 can be varied in different portions of the structural member 20. In this method, the structural member 20 can be heated to higher temperatures because the composite material 22 is added after bending.

As an alternative method, the composite material 22 could be injected while the structural member 20 is being bent.

To selectively position the composite material 22 in only a portion of the structural member 20, spacers (not shown) having a profile matching the interior of the tube 20 may be placed in the tube 20 in a predetermined position. An injector including a second spacer 30 can then be inserted through one end of the structural member 20 and guided to a position with the second spacer 30 being spaced a predetermined distance from the first spacer. The second spacer (not shown) also has a profile matching the interior of the structural member 20, and therefore, a gap is created in the tube 20 between the first and second spacers. A base material (not shown) is then injected into the gap of the structural member 20 with the injector, and the base material is allowed to expand into a composite material 22 that fills the gap between the first and second spacers. The density of the composite material 22 can be increased by increasing the amount of resin injected into the gap between the first and second spacers, or in some embodiments through applying additional heat, such as to Perlite. The injector including the second spacer and/or the first spacer can be removed from the structural member 20 after the base material has finished expanding.

In order to optimize the strength and weight of the reinforced tube 20, the forces that the reinforced structural member 20 is to be subjected to should first be analyzed. A thickness of the structural member 20 can then be selected to be strong enough to withstand the forces likely to occur in the lowest force portion of the structural member 20. The composite material 22 then can be selectively inserted into the portions of the structural member 20 which are to be subject to greater forces. The type and density of the composite material 22 is selected to prevent failure of the tube 20 at those increased forces.

A reinforced structural member 20 having an interior and at least one bend 24 may be reinforced by the composite material. A composite material 22 is selectively positioned in the interior of the structural member 20 for reinforcing the portions of the structural member 20 that are subject to greater forces than the rest of the structural member 20 to allow for a reduced thickness of the structural member 20 without compromising the ability of the structural member 20 to resist the forces.

A method of reinforcing a structural member 20 comprising the step of providing a structural member 20 having an interior. The method continues with the step of selectively inserting a foam 22 into the interior of the structural member 20 for reinforcing portions of the structural member 20 subject to greater forces than other portions of the structural member 20 to allow for a reduced thickness of the structural member 20 without compromising the ability of the structural member 20 to resist the forces. The method also includes the step of heating at least one portion of the structural member 20. The method also includes the step of bending the structural member 20 at the heated portion.

The above different compositions allow for different processing techniques. The percentage of Perlite or cenospheres used may vary the type of process used to form the final structural member. For example, the bending process for high concentrations of cenospheres may be difficult, and also the bending process for high concentrations of cenospheres or Perlite may be sensitive to the time elapsed after filling, creating difficulties in bending once the material has cured within the tube. Therefore, with high concentrations of Perlite or cenospheres, it may be preferable to bend the tube first. In addition, as the amount of urethane increases, it is more likely that it is desirable to weld the tube before adding the composite material.

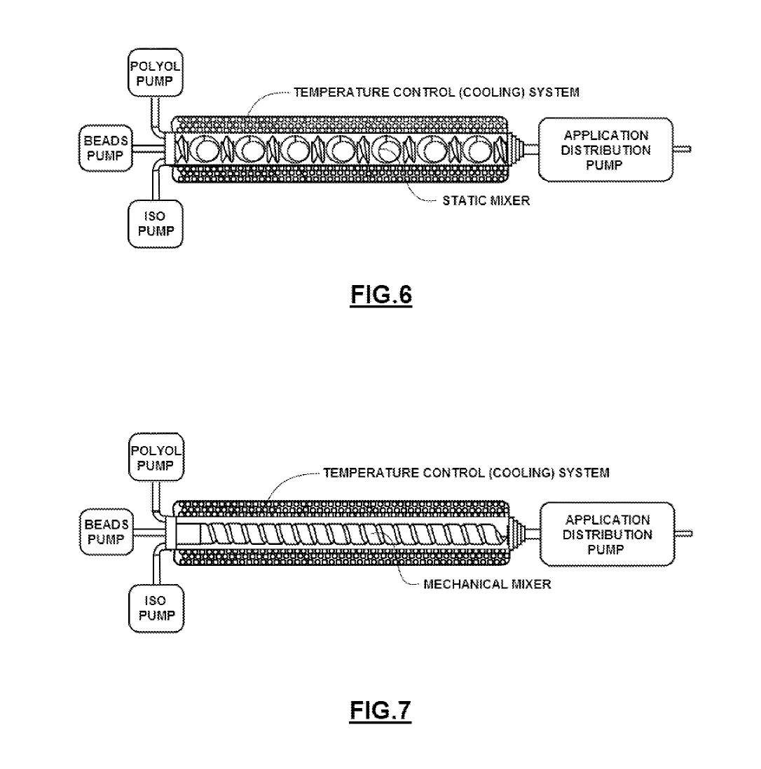

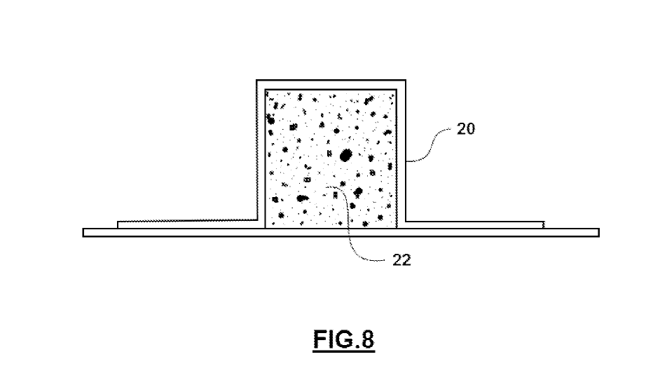

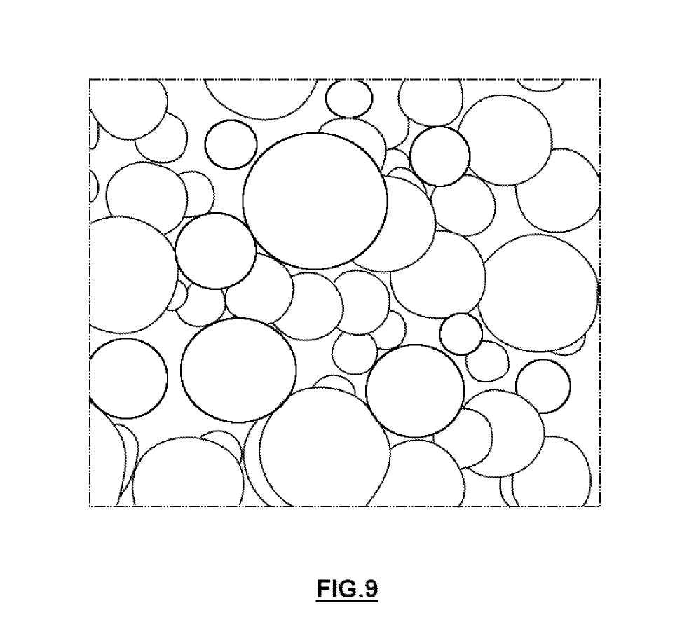

FIGS. 6 and 7 illustrate a static mixer and a mechanical mixer that mix the cenospheres or Perlite with MDI or the isocyanate, and then pump or inject the composite material into the tubes.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A composite material for providing reinforcement to enclosed structural members, said composite material comprising:
15-65% by weight polyol;
0.1-3% by weight water;
10-95% by weight ceramic microspheres, perlite or a combination of ceramic microspheres and Perlite and wherein said ceramic microspheres are substantially hollow;
5-30% polymeric diphenylmethane diisocyanate; and
0.1-5% surfactant and wherein said surfactant is soluble in isocyanate and polyol.

2. The composite material of claim 1 including 10-95% by weight ceramic microspheres and wherein said composite material is substantially free from added perlite.

3. The composite material of claim 2 wherein said polyol and said water form a polyol premix that is mixed with an isocyanate premix formed from said ceramic microspheres and said polymeric diphenylmethane diisocyanate and wherein said polyol premix and said isocyanate premix are mixed and inserted into the enclosed structural member.

4. The composite material of claim 2 wherein said ceramic microspheres range in size from 10-600 microns and are approximately spherical in shape.

5. The composite material of claim 2 wherein said ceramic microspheres have a density of approximately 0.20-0.60 g/cm³.

6. The composite material of claim 1 wherein said polyol includes 5-15% free nitrogen.

7. The composite material of claim 1 wherein said polyol is selected from the group consisting essentially of Hyperlite E-850, Hyperlite E-824 and Multranol 4050.

8. The composite material of claim 2 wherein said diphenylmethane diisocyanate; is selected from the group consisting essentially of Mondur 489, Voranol RA 800 by Dow, Quadrol by BASF and Multranol 4050 by Bayer.

9. The composite material of claim 2 wherein said polyol includes at least four nitrogen groups with two amine groups at each end, plus a hydroxyl group and is configured to act as a catalyst with the hydroxyl group.

10. The composite material of claim 2 wherein said surfactant is a silicone polyether copolymer.

11. The composite material of claim 2 wherein said diphenylmethane diisocyanate includes 3-48% free NCOs.

12. The composite material of claim 2 wherein said polyol includes styrene acrylonitrile.

13. The composite material of claim 2 wherein said cenospheres have a bulk density of 64-352 kg/m³, a specific gravity of 0.6-0.8, a compressive strength of 3000-6500 lbs. per square inch and a softening point above 1900 degrees F.

14. The composite material of claim 2 wherein on a 100 part by weight basis of polyol, the composite material includes 0.1-3 parts water, 2-8 parts by weight silicone polyether copolymer, 100-180 parts by weight aromatic isocyanate, 50-90 parts by weight cenospheres, 1.6-12 parts by weight polymeric acid, and up to 5 parts by weight catalyst.

15. The composite material of claim 14 wherein said cenospheres form 60-85 parts by weight.
